(19) United States
(12) Patent Application Publication
(10) Pub. No.: US 2020/0317389 A1
(43) Pub. Date: Oct. 8, 2020

(54) WRAP AROUND TRAY PREASSEMBLY

(71) Applicant: Royal Box Group, LLC, Indianapolis, IN (US)

(72) Inventors: Timothy P. Burda, Cleves, OH (US); Mark D. Rivas, Melbourne, KY (US)

(21) Appl. No.: 16/843,551

(22) Filed: Apr. 8, 2020

Related U.S. Application Data
(60) Provisional application No. 62/831,088, filed on Apr. 8, 2019.

(51) Int. Cl. B65D 5/20; B31B 50/26

(52) U.S. Cl. CPC B65D 5/20; B31B 50/26

(57) ABSTRACT

The inventive concepts relate generally to a wraparound tray, and more particularly to a wraparound tray preassembly formable into an erected wraparound by folding the tray preassembly around a product to be held within. The tray preassembly is configured so that minimal assembly steps are needed to erect the wraparound tray around the product.

### CROSS REFERENCE TO RELATED APPLICATION

This application claims the benefit under 35 U.S.C. 119(e) of U.S. provisional application Ser. No. 62/831,088, filed Apr. 8, 2019, the contents of which are incorporated herein by reference in their entirety.

### FIELD OF THE INVENTION

The invention relates generally to a wraparound tray, and more particularly to a wraparound tray preassembly formable into an erected wraparound by folding it around a product to be held within, typically a rigid product. The positioning of the product, and folding and sealing of the final container/box can be performed by automatic equipment.

### BACKGROUND OF THE INVENTION

Wrap around trays, or “wraparounds,” allow a packer to place the product onto a flat tray, and then form the erected tray/box around the product. This is in contrast to a typical erected container where the container is formed first, the product is dropped in, and the container top is then folded or added as a separate piece. A wraparound allows for tighter dimensional tolerances between the product and the container walls in comparison to a pre-formed container. Wraparounds are particularly well suited for rigid items, allowing the tray to wrap around the item with little or no spacing between the product and the tray walls.

Prior art wraparound trays typically are sent to the packer in flat blank form unglued. Additional components and add-ons, such as fillers and steps to be added to the tray, are formed separately and shipped to the packer as separate components.

Prior art wrap around trays must be folded and glued fully during the packing operation. Although automated machinery can be used for the folding and gluing processes, any additional components or add-ons need to be attached at the packer, typically by hand, further complicating the packing process.

Benefits and advantages are believed possible with a flat form tray preassembly that can be sent to the packer mostly pre-glued, and with any add-ons already added, so that only the final folding and gluing needs to take place during the packing operation.

### SUMMARY

The disclosed technology relates generally to a wraparound tray, and more particularly to a wraparound tray preassembly formable into an erected wraparound by folding the tray preassembly around a product to be held within.

In one aspect, the disclosed technology relates to a wraparound tray preassembly that can be assembled into an erected wraparound tray. The tray preassembly includes a bottom panel; a front wall having a front panel attached to the bottom panel; a rear wall having a rear panel attached to the bottom panel; and a first side wall. The first side wall includes a side panel attached to the bottom panel; a side panel rollover attached to the side panel and being folded into a face to face relationship with the side panel; a glue tab attached to the side panel rollover and secured to the bottom panel; and a first overlapping side panel attached to one of the front panel and the rear panel and configured to overlap the side panel when the wraparound tray preassembly is assembled into the erected wraparound tray.

In another aspect of the disclosed technology, the wraparound tray preassembly is substantially flat.

In another aspect, the front wall further includes a front panel rollover secured to the front panel in a face to face relationship with the front panel.

In another aspect, the rear wall further includes a rear panel rollover secured to the rear panel in a face to face relationship with the rear panel.

In another aspect, the first overlapping side panel is attached to the rear panel; and the first side wall further includes a second overlapping side panel attached to the front panel and configured to overlap the first overlapping side panel when the wraparound tray preassembly is assembled into the erected wraparound tray.

In another aspect, the first side wall further includes a shoulder panel; the side panel rollover is attached to the side panel by way of the shoulder panel; and the shoulder panel is configured to form a shoulder of the erected wraparound tray.

In another aspect, the front panel is attached to and separated from the bottom panel along a first fold line; the rear panel is attached to and separated from the bottom panel along a second fold line; the side panel is attached to and separated from the bottom panel along a third fold line; the glue tab is attached to and separated from the side panel rollover along a fourth fold line; and the first overlapping side panel is attached to and separated from the front panel or the rear panel along a fifth fold line.

In another aspect, the wraparound tray preassembly further includes a second side wall having a side panel attached to the bottom panel on an opposite side of the bottom panel from the side panel of the first side wall. The second side wall also includes a side panel rollover attached to the side panel of the second side wall and being folded into a face to face relationship with the side panel of the second side wall; and a glue tab attached to the side panel rollover of the second wide wall and adhered to the bottom panel. The second side wall also has a first overlapping side panel attached to one of the front panel and the rear panel and configured to overlap the side panel of the second side wall when the wraparound tray preassembly is assembled into the erected wraparound tray.

In another aspect, the first overlapping side panel is further configured to be adhered to the side panel when the wraparound tray preassembly is assembled into the erected wraparound tray.

In another aspect, the disclosed technology relates to an erected wrap around tray formed from the above-described wraparound tray preassembly.

In another aspect, the front panel is integrally attached to the bottom panel; the rear panel is integrally attached to the bottom panel; the side panel is integrally attached to the bottom panel; the glue tab is integrally attached to the side panel rollover; and the first overlapping side panel is integrally attached to the front panel or the rear panel.

In another aspect, the side panel and the side panel rollover are configured to assume a substantially parallel relationship when the wraparound tray preassembly is assembled into the erected wraparound tray.

In another aspect, the glue tab is secured to the bottom panel by an adhesive.

In another aspect, the wraparound tray preassembly further includes a shelf/filler attached to the rear panel rollover, and a second glue tab attached the shelf/filler and secured to the bottom panel. The shelf/filler has a first half, and a second half attached to and separated from the first half by a sixth fold line. The first and second halves are configured to assume a substantially perpendicular relationship when the wraparound tray preassembly is assembled into the erected wraparound tray.

In another aspect, the disclosed technology relates to a method for assembling an erected wraparound tray. The method includes providing a substantially flat wraparound tray preassembly. The tray preassembly includes a bottom panel; a front wall having a front panel attached to and separated from the bottom panel along a first fold line; a rear wall having a rear panel attached to and separated from the bottom panel along a second fold line; and a first side wall. The first side wall includes a side panel attached to and separated from the bottom panel along a third fold line; a side panel rollover folded into a face to face relationship with the side panel; a glue tab attached to and separated from the side panel rollover by a fourth fold line and secured to the bottom panel; and a first overlapping side panel attached to and separated from one of the front panel and the rear panel by a fifth fold line.

The method includes simultaneously folding the side panel and the side panel rollover about the respective third and fourth fold lines so that the side panel and the side panel rollover each assume a substantially perpendicular orientation in relation to the bottom panel. The method also includes folding the front panel about the first fold line so that the front panel assumes a substantially perpendicular orientation in relation to the bottom panel; and folding the rear panel about the second fold line so that the rear panel assumes a substantially perpendicular orientation in relation to the bottom panel. The method further includes folding the first overlapping side panel about the fifth fold line so that the first overlapping side panel overlaps the side panel; and securing the first overlapping side panel to the side panel.

In another aspect, the first overlapping side panel is attached to and separated from the rear panel along the fifth fold line; and the first side wall further comprises a second overlapping side panel attached to and separated from the front panel by a sixth fold line. The method further includes folding the second overlapping side panel about the sixth fold line so that the second overlapping side panel overlaps at least one of the first overlapping side panel and the side panel; and securing the second overlapping side panel to the first overlapping side panel or the second side panel.

In another aspect, the wraparound tray preassembly further includes a rear panel rollover secured to the rear panel in a face to face relationship with the rear panel; a shelf/filler attached to and separated from the rear panel rollover along a seventh fold line; and a second glue tab attached to and separated from the shelf/filler along an eighth fold line. The shelf/filler has a first half, and a second half attached to and separated from the first half by a ninth fold line. The method further includes folding the shelf/filler around the seventh, eighth, and ninth fold lines so that the first and second halves of the shelf/filler assume a substantially perpendicular relationship.

In another aspect, the wraparound tray preassembly further includes a second side wall. The second side wall has a side panel attached to and separated from the bottom panel by a tenth fold line; a side panel rollover folded into a face to face relationship with the side panel of the second side wall; a glue tab attached to and separated from the side panel rollover of the second side wall by an eleventh fold line and secured to the bottom panel; and a first overlapping side panel attached to and separated from one of the front panel and the rear panel by a twelfth fold line.

The method further includes simultaneously folding the side panel and the side panel rollover of the second side wall about the respective tenth and eleventh fold lines so that the side panel and the side panel rollover of the second side wall assume a substantially perpendicular orientation in relation to the bottom panel; folding the first overlapping side panel of the second side wall about the twelfth fold line so that the first overlapping side panel of the second side wall overlaps the side panel of the second side wall; and securing the first overlapping side panel of the second side wall to the side panel of the second side wall.

In another aspect, the first overlapping side panel of the second side wall is attached to and separated from the rear panel along the twelfth fold line; and the second side wall further includes a second overlapping side panel attached to and separated from the front panel by a thirteenth fold line. The method further includes folding the second overlapping side panel of the second side wall about the thirteenth fold line so that the second overlapping side panel of the second side wall overlaps at least one of the first overlapping side panel and the side panel of the second side wall; and securing the second overlapping side panel of the second side wall to the first overlapping side panel or the second side panel of the second side wall.

In another aspect, the method further includes comprising placing an item to be packaged on the bottom panel before folding the side panel, the side panel rollover; the front panel; the rear panel; and/or the first overlapping side panel.

In another aspect, the disclosed technology relates to a blank for forming the above wraparound tray preassembly.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top perspective view of a first embodiment of the invention showing a fully formed tray;

FIG. 2 is a plan view of a blank for forming the tray of FIG. 1;

FIGS. 3-5 are plan views showing the blank of FIG. 2 going through various steps for forming a flat wrap around tray preassembly as shown in FIG. 6, which is capable of forming the erected tray of FIG. 1;

FIG. 6 is a plan view of a wraparound tray preassembly formed from the blank of FIG. 2 via the steps shown in FIGS. 3-5;

FIG. 7-8 are plan views showing the flat wrap around tray preassembly of FIG. 6 going through various steps for forming the erected tray shown in FIG. 1;

FIG. 9 is a top perspective view of a second embodiment of the invention showing a fully formed tray, similar to that of FIG. 1 but with partial overlapping side panels;

FIG. 10 is a plan view of a blank for forming the tray of FIG. 9;

FIGS. 11-13 are plan views showing the blank of FIG. 10 going through various steps for forming a wrap around tray preassembly as shown in FIG. 14, which is capable of forming the erected tray of FIG. 9;

FIG. 14 is a plan view of a flat wrap around tray preassembly formed from the blank of FIG. 2 via the steps shown in FIGS. 11-13;

FIG. 15-16 are plan views showing the flat wrap around tray preassembly of FIG. 14 going through various steps for forming the erected tray shown in FIG. 9;

FIG. 17 is a top perspective view of a third embodiment of the invention showing a fully formed tray, similar to that of FIG. 1 but with an internal step feature;

FIG. 18 is a plan view of a blank for forming the tray of FIG. 17;

FIGS. 19-21 are plan views showing the blank of FIG. 18 going through various steps for forming a flat wrap around tray preassembly as shown in FIG. 226, which is capable of forming the erected tray of FIG. 17;

FIG. 22 is a plan view of a flat wrap around tray preassembly formed from the blank of FIG. 18 via the steps shown in FIGS. 19-21;

FIG. 23-24 are plan views showing the flat wrap around tray preassembly of FIG. 22 going through various steps for forming the erected tray shown in FIG. 17;

FIG. 25 is a top perspective view of a fourth embodiment of the invention showing a fully formed tray hiaving low height walls;

FIG. 26 is a plan view of a blank for forming the tray of FIG. 25;

FIGS. 27-29 are plan views showing the blank of FIG. 26 going through various steps for forming a flat wrap around tray preassembly as shown in FIG. 30, which is capable of forming the erected tray of FIG. 25;

FIG. 30 is a plan view of a flat wrap around tray preassembly formed from the blank of FIG. 26 via the steps shown in FIGS. 27-29; and

FIG. 31-32 are plan views showing the flat wrap around tray preassembly of FIG. 22 going through various steps for forming the erected tray shown in FIG. 25.

### DETAILED DESCRIPTION OF THE INVENTION

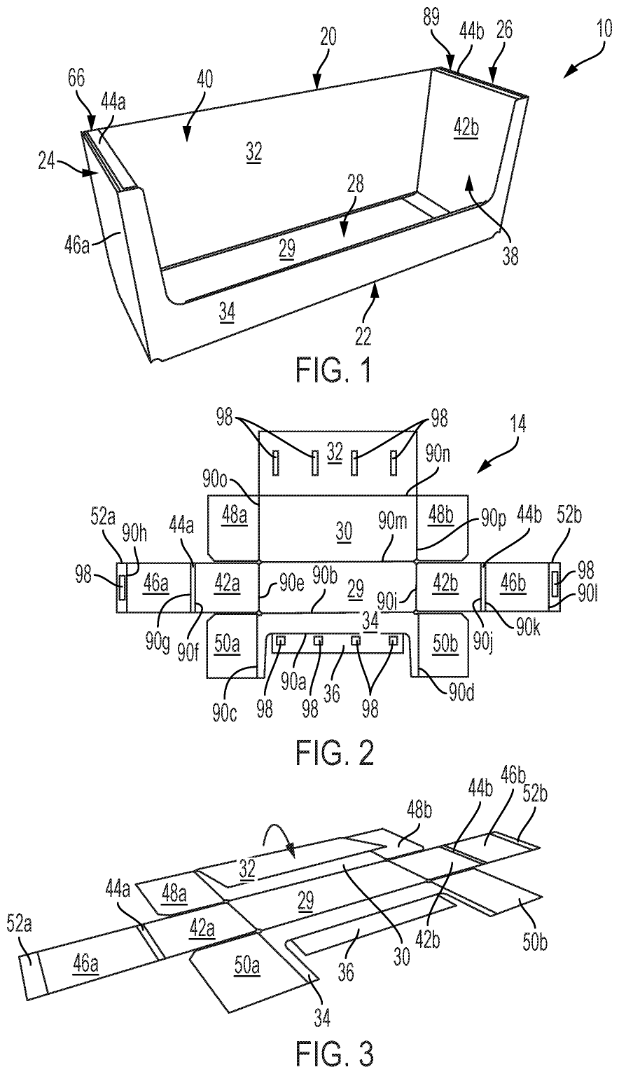

With initial reference to FIG. 1, the present invention provides a fully formed wraparound tray 10. The wraparound tray 10 is erected from a substantially flat wraparound tray preassembly 12, depicted in FIG. 6. The wraparound tray preassembly 12 is formed from a blank 14, shown in FIG. 2, though a series of steps shown in FIGS. 3-5 and described in detail below.

As shown in FIG. 1, the fully formed tray 10 includes a rear wall 20; a front wall 22; a first side wall 24; a second side wall 26; and a bottom 28. The bottom 28 is formed from a bottom panel 29. The rear wall 20 is formed from a rear panel 30, and a rear panel rollover 32 shown in FIG. 2. The rear panel 30 is substantially perpendicular to the bottom panel 29 when the wraparound tray 10 is in its fully formed state shown in FIG. 1. A first, or lower edge of the rear panel 30 adjoins the bottom panel 29. With reference to the component orientations depicted in FIG. 1, the rear panel rollover 32 adjoins a second, or upper edge of the rear panel 30. Upon being rolled over onto the rear panel 30, the rear panel rollover 32 is secured to the rear panel 30 by adhesive or other suitable means.

The front wall 22 is formed from a front panel 34, and a front panel rollover 36 shown in FIG. 2. The front panel 34 is substantially perpendicular to the bottom panel 29 when the wraparound tray 10 is in its fully formed state shown in FIG. 1. A first, or lower end of the front panel 34 adjoins the bottom panel 29. The front panel rollover 36 adjoins a second, or upper edge the front panel 34. Upon being rolled over onto the front panel 34, the front panel rollover 36 is secured to the front panel 34 by adhesive or other suitable means. As can be seen in FIG. 1, the upper edge of the front panel 34 defines a display opening 38 that provides visual and physical access to an interior volume 40 of the wraparound tray 10.

Referring to FIG. 2, the first side wall 24 includes a side panel 42a; a shoulder panel 44a; a side panel rollover 46a; a first overlapping side panel 48a; a second overlapping side panel 50a; and a glue tab 52a. The side panel 42a is substantially perpendicular to the bottom panel 29 when the wraparound tray 10 is in its fully formed state shown in FIG. 1. A first, or lower edge of the side panel 42a adjoins the bottom panel 29. The shoulder panel 44a adjoins a second, or upper edge of the side panel 42, and a second, or upper edge of the side panel rollover 46a. The shoulder panel 44a forms a first shoulder 66 of the tray 10, as shown in FIG. 1. A first, or lower edge 68 of the side panel rollover 46a adjoins the glue tab 52a. The glue tab 52a is secured to the bottom panel 29 by adhesive or other suitable means when the wraparound tray 10 is in its fully formed state. The glue tab 52a helps to maintain the side panel rollover 46a and the side panel 42a in a substantially upright orientation.

An inwardly-facing, or inner side of the first overlapping side panel 48a is secured to an outwardly-facing, or outer side of the side panel 42a by adhesive or other suitable means when the wraparound tray 10 is in its fully formed state shown in FIG. 1. An outwardly-facing side of the first overlapping side panel 48a is secured to an inwardly-facing side of the second overlapping side panel 50a by adhesive or other suitable means when the wraparound tray 10 is in its fully formed state.

Referring to FIG. 2, the second side wall 26 includes a side panel 42b; a shoulder panel 44b; a side panel rollover 46b; a first overlapping side panel 48b; a second overlapping side panel 50b; and a glue tab 52b. The side panel 42b is substantially perpendicular to the bottom panel 29 when the wraparound tray 10 is in its fully formed state. A first, or lower edge of the side panel 42b adjoins the bottom panel 29. The shoulder panel 44b adjoins a second, or upper edge 86 of the side panel 42b, and a second, or upper edge 88 of the side panel rollover 46b. The shoulder panel 44b forms a second shoulder 89 of the tray 10. A first, or lower edge 92 of the side panel rollover 46b adjoins the glue tab 52b. The glue tab 52b is secured to the bottom panel 29 by adhesive or other suitable means when the wraparound tray 10 is in its fully formed state. The glue tab 52b helps to maintain the side panel rollover 46b and the side panel 42b in a substantially upright orientation.

An inwardly-facing side of the first overlapping side panel 48b is secured to an outwardly-facing side of the side panel 42b by adhesive or other suitable means when the wraparound tray 10 is in its fully formed state. An outwardly-facing side of the first overlapping side panel 48b is secured to an inwardly-facing side of the second overlapping side panel 50b by adhesive or other suitable means when the wraparound tray 10 fully formed.

With reference to FIG. 6, an exemplary blank 14 for forming the tray 10 is described. The blank 14 is a unitary or single piece of suitable corrugated paperboard cut normally from a larger sheet of material.

The blank 14 incudes the bottom panel 29; the front panel 34; the front panel rollover 36; the second overlapping side panel 50a; and the second overlapping side panel 50b. The front panel rollover 36 is attached to a first, or upper edge of the front panel 34. A fold line 90a is formed at the interface between the front panel rollover 36 and the front panel 34. The fold line 90a, and the other fold lines referenced herein, can be formed in any known manner, including score lines or any other means that aids in folding. A second edge of the front panel 34 is attached to a first edge of the bottom panel 29. A fold line 90b is formed at the interface between the front panel 34 and the bottom panel 29.

The second overlapping side panel 50a is attached to a third edge of the front panel 34. A fold line 90c is formed at the interface between the second overlapping side panel 50a and the front panel 34. The second overlapping side panel 50b is attached to a fourth edge of the front panel 34. A fold line 90d is formed at the interface between the second overlapping side panel 50b and the front panel 34.

The blank 14 also includes the side panel 42a; the shoulder panel 44a; the side panel rollover 46a; and the glue tab 52a. A first edge of the side panel 42a is attached to a second edge of the bottom panel 29. A fold line 90e is formed at the interface between the side panel 42a and the bottom panel 29. A second edge of the side panel 42a is attached to a first edge of the shoulder panel 44a. A fold line 90f is formed at the interface between the side panel 42a and the shoulder panel 44a. A second edge of the shoulder panel 44a is attached to a first edge of the side panel rollover 46a. A fold line 90g is formed at the interface between the side panel rollover 46a and the shoulder panel 44a. A second edge of the side panel rollover 46a is attached to the glue tab 52a. A fold line 90h is formed at the interface between the side panel rollover 46a and the glue tab 52a.

The blank 14 further includes the side panel 42b; the shoulder panel 44b; the side panel rollover 46b; and the glue tab 52b. A first edge of the side panel 42b is attached to a third edge of the bottom panel 29. A fold line 90i is formed at the interface between the side panel 42b and the bottom panel 29. A second edge of the side panel 42b is attached to a first edge of the shoulder panel 44b. A fold line 90j is formed at the interface between the side panel 42b and the shoulder panel 44b. A second edge of the shoulder panel 44b is attached to a first edge of the side panel rollover 46b. A fold line 90k is formed at the interface between the side panel rollover 46b and the shoulder panel 44b. A second edge of the side panel rollover 46b is attached to the glue tab 52b. A fold line 901 is formed at the interface between the side panel rollover 46b and the glue tab 52b.

The blank 14 further includes the rear panel 30; the rear panel rollover 32; the first overlapping side panel 48a, and the first overlapping side panel 48b. A first edge of the rear panel 30 is attached to a fourth edge of the bottom panel 29. A fold line 90m is formed at the interface between the rear panel 30 and the bottom panel 29. A second edge of the rear panel 30 is attached to an edge of the rear panel rollover 32. A fold line 90n is formed at the interface between the rear panel 30 and the rear panel rollover 32.

An edge of the first overlapping side panel 48a is attached to a second edge of the rear panel 30. A fold line 90o is formed at the interface between the first overlapping side panel 48a and the rear panel 30. An edge of the first overlapping side panel 48b is attached to a third edge of the rear panel 30. A fold line 90p is formed at the interface between the first overlapping side panel 48b and the rear panel 30.

The wraparound tray preassembly 12 can be formed from the blank 14 as follows. An adhesive 98, such as holt melt glue, is applied to a surface of the rear panel rollover 32; a surface of the glue tab 52a; surface of the glue tab 52b; and a surface of the front panel rollover 36, as shown in FIG. 2. The adhesive 98 can be applied in various thicknesses at each of the noted locations. Also, the adhesive can be applied simultaneously to all of the noted locations, or at different points during the formation of the wraparound tray preassembly 12.

As depicted in FIG. 3, the rear panel rollover 32 is then rotated or rolled about the fold line 90n and toward an inner surface of the rear panel 30 by about 180 degrees, so that the rear panel rollover 32 eventually contacts the inner surface of the rear panel 30. The adhesive 98 secures the rear panel rollover 32 to the rear panel 30.

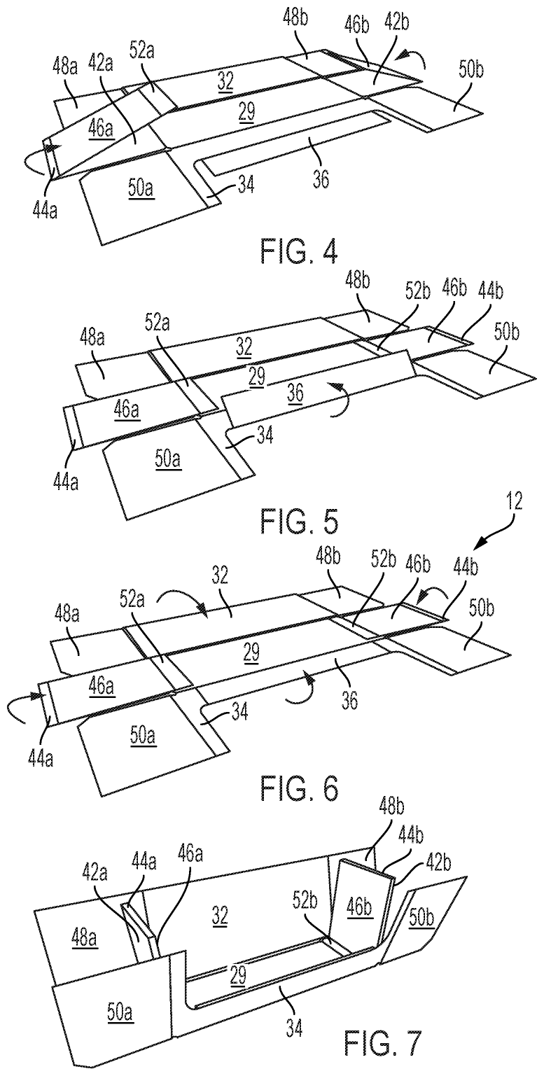

As illustrated in FIG. 4, the shoulder panel 44a, the side panel rollover 46a, and the glue tab 52a are then rotated or rolled about the fold line 90f by about 180 degrees. This action causes the glue tab 52a to rotate toward, and eventually contact the inner surface of the bottom panel 29. The adhesive 98 on the glue tab 52a secures the glue tab 52a to the bottom panel 29. As can be seen in FIG. 5, once the shoulder panel 44a, the side panel rollover 46a, and the glue tab 52a have been folded, the shoulder panel 44a and the side panel rollover 46a overlap the side panel 42a. Also, the fold line 90h between the glue tab 52a and the side panel rollover 46a is offset inwardly in relation to the fold line 90e between the side panel 42a and the bottom panel 29, by a distance about equal to the width of the shoulder panel 44a.

As further illustrated in FIG. 4, the shoulder panel 44b, the side panel rollover 46b, and the glue tab 52b are rotated or rolled about the fold line 90j by about 180 degrees. This action causes the glue tab 52b to rotate toward, and eventually contact the inner surface of the bottom panel 29. The adhesive 98 on the glue tab 52b secures the glue tab 52b to the bottom panel 29. As can be seen in FIG. 5, once the shoulder panel 44b, the side panel rollover 46b, and the glue tab 52b have been folded, the shoulder panel 44b and the side panel rollover 46b overlap the side panel 42b. Also, the fold line 901 between the glue tab 52b and the side panel rollover 46b is offset inwardly in relation to the fold line 90i between the side panel 42b and the bottom panel 29, by a distance about equal to the width of the shoulder panel 44b.

As shown in FIG. 5, the front panel rollover 36 is then rotated or rolled about the fold line 90a and toward an inner surface of the front panel 34 by about 180 degrees, so that the front panel rollover 36 eventually contacts the inner surface of the front panel 34. The adhesive 98 secures the front panel rollover 36 to the front panel 34.

The wraparound tray preassembly 12 at this point has been fully formed as depicted in FIG. 5, and is ready to be erected into the wraparound tray 10 shown in FIG. 1. The wraparound tray preassembly 12 can be stacked with other wraparound tray assemblies 12 for storage, and/or for shipment to the packer's facility or other location at which the wraparound tray preassembly 12 will be loaded with product and erected into the wraparound tray 10. The above-noted activities for forming the wraparound tray preassembly 12 from the blank 14 can be performed in an order other than that described above.

The wraparound tray preassembly 12 can be erected into the fully formed wraparound tray 10 as follows. The product that the wraparound tray 10 is to hold can be placed on the bottom panel 29 of the wraparound tray preassembly 12. The rear wall 20; front wall 22; first side wall 24; and second side wall 26 are then folded up around the product as shown in FIG. 7. Specifically, the front panel 34 and the attached front panel rollover 36 are rotated or rolled about the fold line 90b by about 90 degrees, into a substantially upright orientation. The rear panel 30 and the attached rear panel rollover 32 are rotated or rolled about the fold line 90m by about 90 degrees, into a substantially upright orientation.

The side panel rollover 46a and side panel 42a, which are attached by way of the shoulder panel 44a, are rotated or rolled about the respective fold lines 90h and 90e by about 90 degrees, into a substantially vertical orientation. The noted movement of the side panel rollover 46a and side panel 42 moves the attached shoulder panel 44a into a substantially horizontal orientation, to form the first shoulder 66 depicted in FIG. 1, as the shoulder panel 44a rotates or rolls in relation to the side panel rollover 46a and side panel 42a about the respective fold lines 90g and 90f.

The side panel rollover 46b and side panel 42b, which are attached by way of the shoulder panel 44b, are rotated or rolled about the respective fold lines 901 and 90i by about 90 degrees, into a substantially vertical orientation. The noted movement of the side panel rollover 46b and side panel 42b moves the attached shoulder panel 44b into a substantially horizontal orientation, to form the second shoulder 89 depicted in FIG. 1, as the shoulder panel 44b rotates or rolls in relation to the side panel rollover 46b and side panel 42b about the respective fold lines 90k and 90j. The rear wall 20, front wall 22, first side wall 24, and second side wall 26 can be folded upward on a simultaneous basis, or in any order.

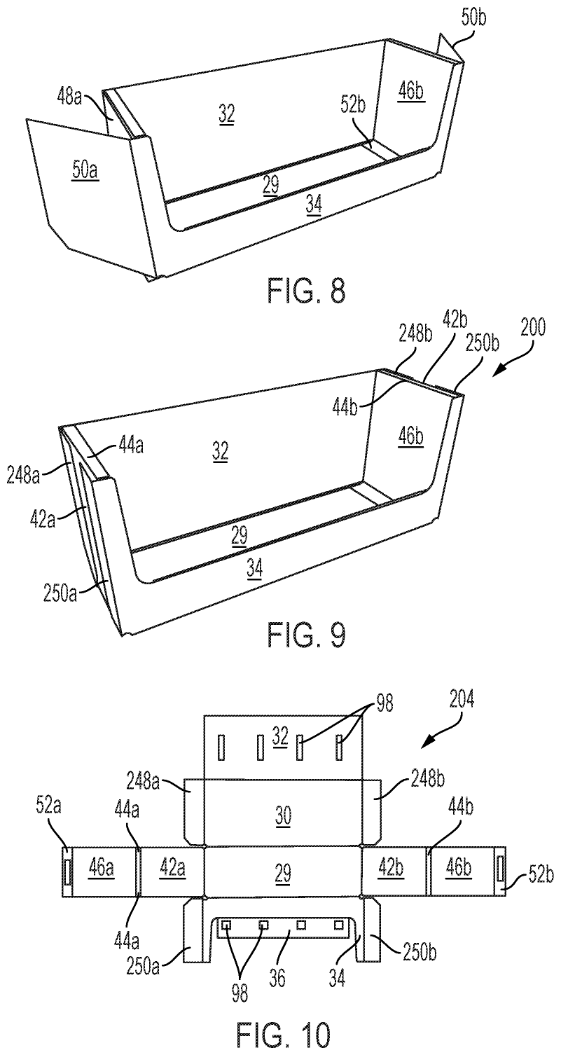

Referring to FIG. 8, once the above activities have been completed, the first overlapping side panel 48a, which has assumed a substantially vertical orientation due to the rotation of the attached rear panel 30, is rotated or rolled about the fold line 90o by about 90 degrees, to bring an inner surface of the first overlapping side panel 48a into contact with an outer, or outwardly-facing surface of the side panel 42a. A suitable adhesive, such as hot melt glue, can be applied to the inner surface of the first overlapping side panel 48a, and/or to the outer surface of the side panel 42a, at the start of the final assembly process or at some time thereafter. The adhesive secures the first overlapping side panel 48a to the side panel 42a.

In a similar manner, the first overlapping side panel 48b, which has assumed a substantially vertical orientation due to the rotation of the attached rear panel 30, is rotated or rolled about the fold line 90p by about 90 degrees, to bring an inner surface of the first overlapping side panel 48b into contact with an outer surface of the side panel 42b. A suitable adhesive, such as hot melt glue, can be applied to the inner surface of the first overlapping side panel 48b, and/or to the outer surface of the side panel 42b, at the start of the final assembly process or at some time thereafter. The adhesive secures the first overlapping side panel 48b to the side panel 42b.

Once the first overlapping side panel 48a has been secured to the side panel 42a in the above manner, the second overlapping side panel 50a, which has assumed a substantially vertical orientation due to the rotation of the attached front panel 34, is rotated or rolled about the fold line 90c, to bring an inner surface of the second overlapping side panel 50a into contact with an outer surface of the first overlapping side panel 48a. A suitable adhesive, such as hot melt glue, can be applied to the inner surface of the second overlapping side panel 50a, and/or to the outer surface of the first overlapping side panel 48a, at the start of the final assembly process or at some time thereafter. The adhesive secures the second overlapping side panel 50a to the first overlapping side panel 48a.

In a similar manner, once the first overlapping side panel 48b has been secured to the side panel 42b in the above manner, the second overlapping side panel 50b, which has assumed a substantially vertical orientation due to the rotation of the attached front panel 34, is rotated or rolled about the fold line 90d, to bring an inner surface of the second overlapping side panel 50b into contact with an outer surface of the first overlapping side panel 48b. A suitable adhesive, such as hot melt glue, can be applied to the inner surface of the second overlapping side panel 50b, and/or to the outer surface of the first overlapping side panel 48b, at the start of the final assembly process or at some time thereafter. The adhesive secures the second overlapping side panel 50b to the first overlapping side panel 48b. The assembly of the wraparound tray 10 is complete at this point.

It is contemplated that the above process for erecting the wraparound tray 10 will be performed by automated equipment, although the process can be performed manually in the alternative.

The front panel 34 and the attached front panel rollover 36 provide the front wall 22 with a relatively strong double-walled construction. The rear panel 30 and the attached rear panel rollover 32 likewise provide the rear wall 20 with a double-walled construction. The double-walled construction is provided without any need to affix separate panels or other add-ons to the front panel 34 or the rear panel 30 while erecting the wraparound tray 10 from the wraparound tray preassembly 12, which in turn permits the final assembly of the wraparound tray 10 to be performed on an entirely automated basis, using exiting automated packing equipment.

The side panel 42a; side panel rollover 46a; first overlapping side panel 48a; and second overlapping side panel 50a give the first side wall 24 a four-walled construction. The side panel 42b; side panel rollover 44b; first overlapping side panel 48b; and second overlapping side panel 50b likewise give the second side wall 26 a four-walled construction. The four-wall construction of the first and second side walls 24, 26 provides the wraparound container 10 with substantial load-bearing capability and crush resistance when stacked or otherwise loaded vertically. This multi-wall construction is provided without a need to affix separate panels or other add-ons to the side panels 42a, 42b while erecting the wraparound tray 10 from the wraparound tray preassembly 12, which in turn permits the final assembly of the wraparound tray 10 to be performed on an entirely automated basis, using existing automated packing equipment. Also, the first and second shoulders 66, 89 provide relatively wide surfaces that facilitate stacking of the fully assembled and loaded wraparound trays 10.

The second overlapping side panels 50a, 50b can act as graphics panels, because the relatively large outwardly facing surfaces of the second overlapping side panels 50a, 50b provide substantial areas for printing such as product labeling and branding, promotional materials, instructions, etc. These graphics panels can be provided without any need to affix add-ons as the wraparound tray preassembly 12 is erected into the wraparound tray 10. The inner surface of the rear panel rollover 32, i.e., the surface of the rear panel rollover 32 that faces the interior volume 40, likewise can act as a graphics panel; and this area can be provided without a need to affix a separate inner panel or other add-ons to the rear panel 30 while erecting the wraparound tray 10.

The flat pre-form of the wraparound tray 10, i.e., the wraparound tray preassembly 12, is sent to the packer in an intermediate, flat, pre-folded, and glued form that has many of the glue joints already made, and that can be stacked for easy shipment and storage by the packer. Add-ons can be attached during by the tray manufacturer during manufacture of the wraparound tray preassembly 12, which can eliminate the need to set up and attach add-ons at the packer's facility. Automated packing equipment can be used to erect the final wraparound tray 10 around the packaged product from the flat, semi-formed wraparound tray preassembly 12 having any desired add-ons pre-attached. Due to the above-described pre-gluing that takes place during manufacture of the wraparound tray preassembly 12, the only gluing that remains to be performed at the packer's facility is the gluing of the first overlapping side panels 48a, 48b to the respective side panels 42a, 42b; and the gluing of the second overlapping side panels 50a, 50b to the respective first overlapping side panels 48a, 48b. Also, features such as the first and second shoulders 66, 89; the self-erecting shelf/filler 307 discussed below; other types of fillers; etc. can be added and glued in place during the manufacturing stage, i.e., during production of the wraparound tray preassembly 12, rather than being added at the packer. This can result in time and cost savings.

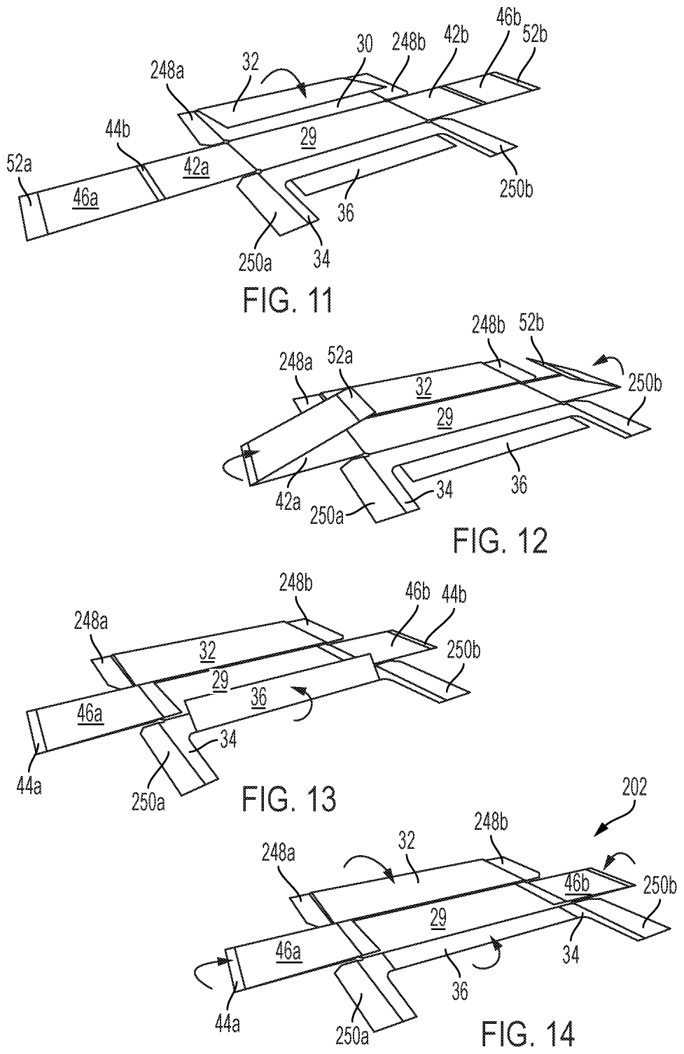

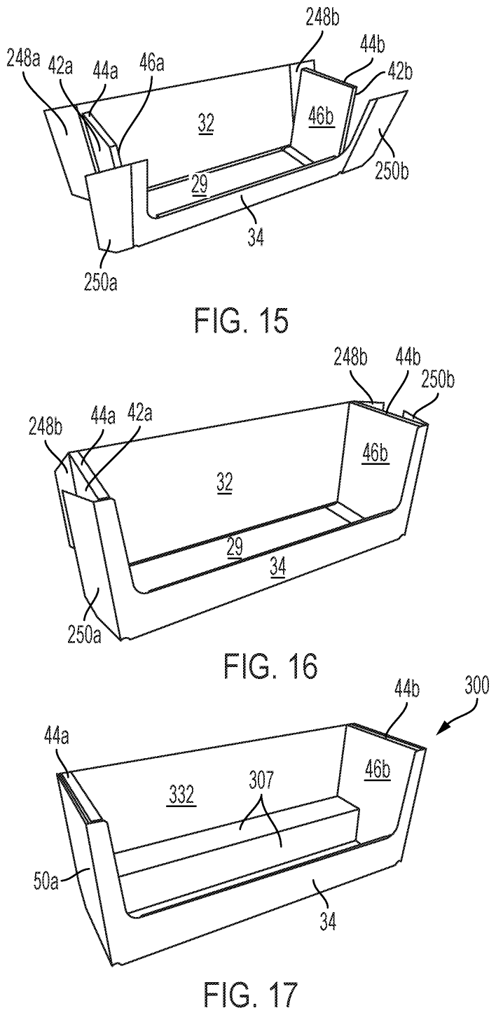

FIGS. 9-16 depict a second embodiment in the form of a wraparound tray 200, and a corresponding wraparound tray preassembly 202 and blank 204 from which the wraparound tray 200 is formed. In particular, FIG. 9 depicts the fully formed wraparound tray 200; FIG. 10 depicts the blank 204; FIGS. 11-14 depict the blank 204 progressively being folded and glued to form the wraparound tray preassembly 202; and FIGS. 15 and 16 depict the wraparound tray preassembly 202 being formed into the wraparound tray 200.

The wraparound tray 200; wraparound tray preassembly 202; and blank 204 are substantially identical to the respective wraparound tray 10, wraparound tray preassembly 12, and blank 14 shown in FIGS. 1-8, with the following exceptions, and the above description of the structure and assembly of the wraparound tray 10, wraparound tray preassembly 12, and blank 14 otherwise apply equally to the wraparound tray 200; wraparound tray preassembly 202; and blank 204. Common reference characters are used in FIGS. 1-16 to denote substantially identical components.

The wraparound tray 200, wraparound tray preassembly 202, and blank 204 have first outer side panels 248a, 248b in lieu of the first overlapping side panels 48a, 48b of the wraparound tray 10, wraparound tray preassembly 12, and blank 14; and second outer side panels 250a, 250b in lieu of the second overlapping side panels 50a, 50b. The first outer side panels 248a, 248b and the second outer side panels 250a, 250b are short in comparison to the first overlapping side panels 48a, 48b and the second overlapping side panels 50a, 50b, and do not overlap, as can be seen in FIGS. 9 and 16.

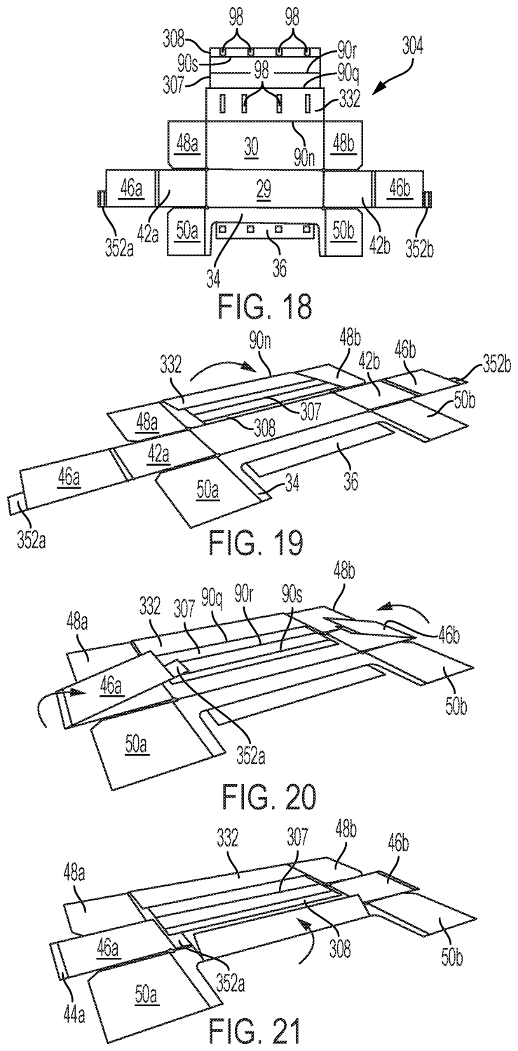

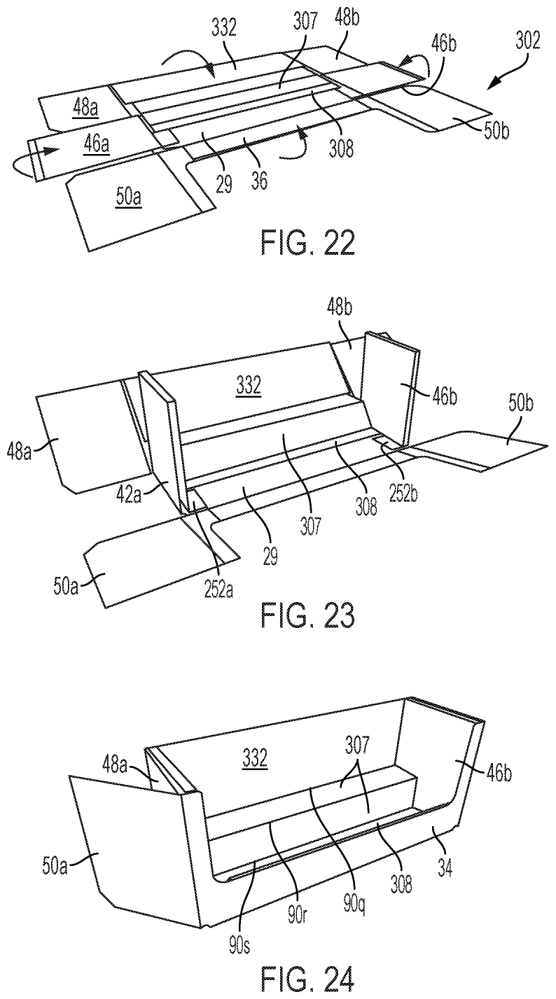

FIGS. 17-24 depict a third embodiment in the form of a fully-assembled wraparound tray 300, and a corresponding wraparound tray preassembly 302 and blank 304 from which the wraparound tray 300 is formed. In particular, FIG. 17 depicts the fully formed wraparound tray 300; FIG. 18 depicts the blank 304; FIGS. 19-21 depict the blank 304 progressively being folded and glued to form the wraparound tray preassembly 302; and FIGS. 23 and 24 depict the wraparound tray preassembly 302 being formed into the wraparound tray 300.

The wraparound tray 300; wraparound tray preassembly 302; and blank 304 are substantially identical to the respective wraparound tray 10, wraparound tray preassembly 12, and blank 14 shown in FIGS. 1-8, with the following exceptions, and the above description of the structure and assembly of the wraparound tray 10, wraparound tray preassembly 12, and blank 14 otherwise apply equally to the wraparound tray 300; wraparound tray preassembly 302; and blank 304. Common reference characters are used in FIGS. 1-8 and 17-24 to denote substantially identical components.

The wraparound tray 300, wraparound tray preassembly 302, and blank 304 have a rear panel rollover 332, a shelf/filler 307, a glue tab 308, and glue tabs 352a, 352b as can be seen in FIG. 17. A first, or upper edge of the rear panel rollover 332 is attached to the rear panel 30. A fold line 90n is formed at the interface between the rear panel 30 and the rear panel rollover 332, as can be seen in FIG. 18. A second edge of the rear panel rollover 332 is attached to a first edge of the shelf/filler 307. A fold line 90q is formed at the interface between the rear panel rollover 332 and the shelf/filler 307. The shelf/filler 307 has a fold line 90r formed therein and extending the length of the shelf/filler 307. The fold line 90r divides the shelf/filler 307 intro two halves. A second edge of the shelf/filler 307 is attached to the glue tab 308. A fold line 90s is formed at the interface between the shelf/filler 307 and the glue tab 308.

As shown in FIG. 19, during formation of the wraparound tray preassembly 302, the rear panel rollover 332, and the attached shelf/filler 307 and glue tab 308, are rotated or rolled by about 180 degrees about the fold line 90n. This action brings the an outwardly-facing surface of the rear panel rollover 332 into contact with an inwardly-facing surface of the rear panel 30; and brings the glue tab 308 into contact with an inwardly-facing surface of the bottom panel 29. The rear panel rollover 332 is attached to the rear panel 30, and the glue tab 308 is attached to the bottom panel 29 by adhesive or other suitable means. The shelf/filler 307 is not directly attached to any underlying structure of the wraparound tray preassembly 302.

During formation of the fully assembled wraparound tray assembly 300, the rear panel 30 and the attached rear panel rollover 332 are rotated or rolled to an upright orientation, as shown in FIGS. 23 and 24. Because the shelf/filler 307 is not attached to any underlying structure, the two halves of the shelf/filler 307 delineated by the fold line 90r rotate about the respective fold lines 90q and 90s, and about the fold line 90r. As a result, the two halves of the shelf/filler 307 rotate into mutually perpendicular orientations, thereby forming the two-sided shelf/filler 307 depicted in FIGS. 17 and 24. The shelf/filler 307 can be used, for example, as a shelf to enhance the display of product within the wraparound tray 300, and/or as a filler to reduce the interior volume of the wraparound tray assembly 300.

As can be seen in FIG. 18, the glue tabs 352a, 352b that adjoin the respective side panel rollovers 46a, 46b are shorter than the corresponding glue tabs 52a, 52b of the wraparound tray 10, wraparound tray preassembly 12, and blank 14, to avoid overlap with the glue tab 308.

As noted above, because the wraparound tray preassembly 302 is configured so that the shelf/filler 307 automatically folds into its final configuration during erection of the wraparound tray 300, forming the shelf/filler 307 does not require any add-ons or additional assembly steps at the packer. The shelves of alternative embodiments can be taller, shorter, wider, and/or narrower than the shelf/filler 307.

The two halves of the shelf/filler 307 are depicted as having substantially identical dimensions. The relative dimensions of the two halves can be different in alternative embodiments. For example, referring to the component orientations depicted in FIG. 24, the lower half can be configured to be shorter or taller than as depicted in FIG. 24, so that the shelf/filler 307 can be shorter or taller than as depicted in FIG. 24, i.e., the shelf/filler 307 can be configured to extend to any height along the rear wall of the tray assembly 300. The dimensions of the two halves likewise can be varied so the shelf/filler 307 extends farther from, or closer to the rear wall than as depicted in FIG. 24. In other alternative embodiments, the shelf/filler 307 can be configured to extend along only a portion of the length of the rear wall.

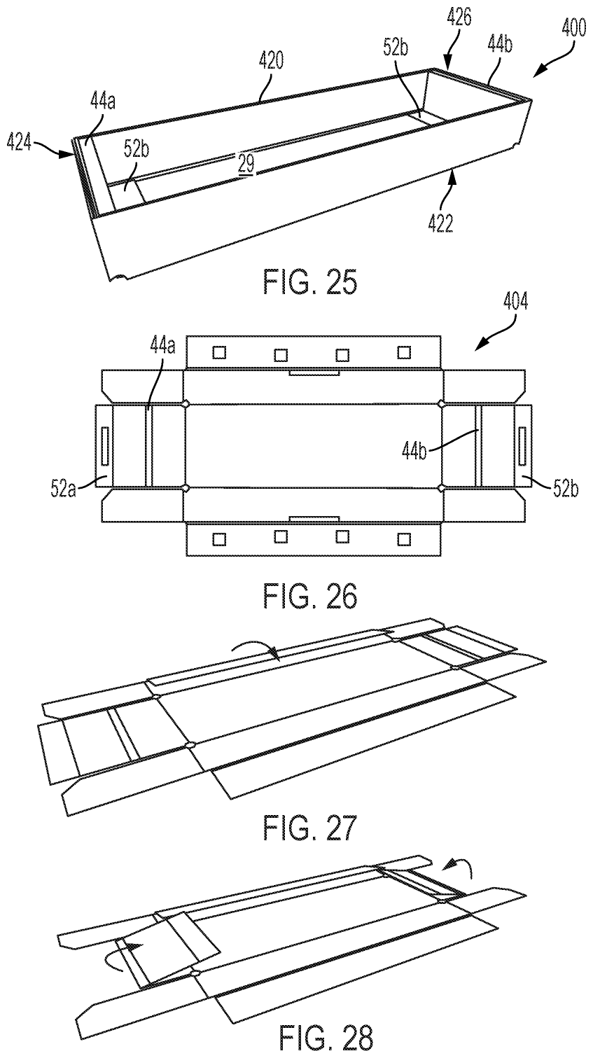

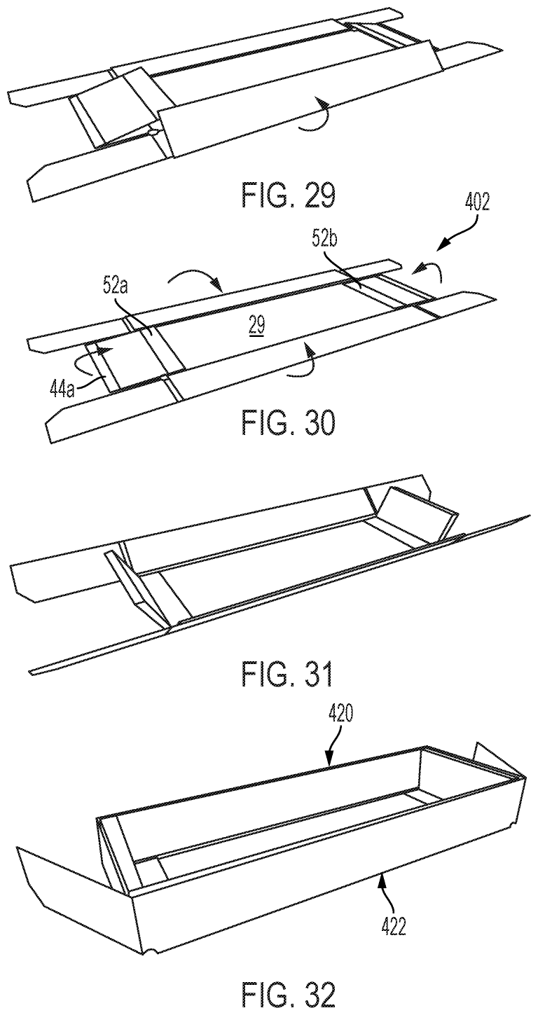

FIGS. 25-32 depict a fourth embodiment in the form of a fully-assembled wraparound tray 400, and the corresponding wraparound tray preassembly 402 and blank 404 from which the wraparound tray 400 is formed. In particular, FIG. 25 depicts the fully formed wraparound tray 400; FIG. 26 depicts the blank 404; FIGS. 27-30 depict the blank 404 progressively being folded and glued to form the wraparound tray preassembly 402; and FIGS. 31 and 32 depict the wraparound tray preassembly 402 being formed into the wraparound tray 400.

The wraparound tray 400; wraparound tray preassembly 402; and blank 404 are substantially identical to the respective wraparound tray 10, wraparound tray preassembly 12, and blank 14 shown in FIGS. 1-8, with the following exceptions, and the above description of the structure and assembly of the wraparound tray 10, wraparound tray preassembly 12, and blank 14 otherwise apply equally to the wraparound tray 400; wraparound tray preassembly 402; and blank 404. Common reference characters are used in FIGS. 1-8 and 25-32 to denote substantially identical components; and common reference characters are used for substantially identical components.

Referring to FIG. 25, the fully-assembled wraparound tray 400 is a low-profile wraparound tray having a rear wall 420; a front wall 422; a first side wall 424; and a second side wall 426 that are substantially shorter, in the vertical direction, than respective rear wall 20, front wall 22, first side wall 24, and second side wall 26 of the wraparound tray 10. The portions of the wraparound tray preassembly 402 and the blank 404 that make up the rear wall 420, front wall 422, first side wall 424, and second side wall 426 have correspondingly smaller dimensions than their counterpart portions in the wraparound tray preassembly 12 and the blank 14. Also, due to its relatively low profile, the fully-assembled wraparound tray 400 does not have a display opening such as the display opening 38 of the wraparound tray 10.

It is appreciated that described above is an illustrated embodiment of the new container system. Other embodiments and configurations of the invention are possible. It is understood that the invention is not limited to the embodiment and illustrations described above.

We claim:

1. A wraparound tray preassembly that can be assembled into an erected wraparound tray, comprising:
a bottom panel;
a front wall comprising a front panel attached to the bottom panel;
a rear wall comprising a rear panel attached to the bottom panel; and
a first side wall comprising: a side panel attached to the bottom panel; a side panel rollover attached to the side panel and being folded into a face to face relationship with the side panel; a glue tab attached to the side panel rollover and secured to the bottom panel; and a first overlapping side panel attached to one of the front panel and the rear panel and configured to overlap the side panel when the wraparound tray preassembly is assembled into the erected wraparound tray.

2. The wraparound tray preassembly of claim 1, wherein the wraparound tray preassembly is substantially flat.

3. The wraparound tray preassembly of claim 1, wherein the front wall further comprises a front panel rollover secured to the front panel in a face to face relationship with the front panel.

4. The wraparound tray preassembly of claim 1, wherein the rear wall further comprises a rear panel rollover secured to the rear panel in a face to face relationship with the rear panel.

5. The wraparound tray preassembly of claim 1, wherein the first overlapping side panel is attached to the rear panel; and the first side wall further comprises a second overlapping side panel attached to the front panel and configured to overlap the first overlapping side panel when the wraparound tray preassembly is assembled into the erected wraparound tray.

6. The wraparound tray preassembly of claim 1, wherein the first side wall further comprises a shoulder panel; the side panel rollover is attached to the side panel by way of the shoulder panel; and the shoulder panel is configured to form a shoulder of the erected wraparound tray.

7. The wraparound tray preassembly of claim 1, wherein the front panel is attached to and separated from the bottom panel along a first fold line; the rear panel is attached to and separated from the bottom panel along a second fold line; the side panel is attached to and separated from the bottom panel along a third fold line; the glue tab is attached to and separated from the side panel rollover along a fourth fold line; and the first overlapping side panel is attached to and separated from the front panel or the rear panel along a fifth fold line.

8. The wraparound tray preassembly of claim 1, further comprising a second side wall, the second side wall comprising:
a side panel attached to the bottom panel on an opposite side of the bottom panel from the side panel of the first side wall;
a side panel rollover attached to the side panel of the second side wall and being folded into a face to face relationship with the side panel of the second side wall;
a glue tab attached to the side panel rollover of the second wide wall and adhered to the bottom panel; and
a first overlapping side panel attached to one of the front panel and the rear panel and configured to overlap the side panel of the second side wall when the wraparound tray preassembly is assembled into the erected wraparound tray.

9. The wraparound tray preassembly of claim 1, wherein the first overlapping side panel is further configured to be adhered to the side panel when the wraparound tray preassembly is assembled into the erected wraparound tray.

10. An erected wrap around tray formed from the wraparound tray preassembly of claim 1.

11. The wraparound tray preassembly of claim 1, wherein the front panel is integrally attached to the bottom panel; the rear panel is integrally attached to the bottom panel; the side panel is integrally attached to the bottom panel; the glue tab is integrally attached to the side panel rollover; and the first overlapping side panel is integrally attached to the front panel or the rear panel.

12. The wraparound tray preassembly of claim 1, wherein the side panel and the side panel rollover are configured to assume a substantially parallel relationship when the wraparound tray preassembly is assembled into the erected wraparound tray.

13. The wraparound tray preassembly of claim 1, wherein the glue tab is secured to the bottom panel by an adhesive.

14. The wraparound tray preassembly of claim 4, further comprising a shelf/filler attached to the rear panel rollover, and a second glue tab attached the shelf/filler and secured to the bottom panel; wherein:
the shelf/filler has a first half, and a second half attached to and separated from the first half by a sixth fold line; and
the first and second halves are configured to assume a substantially perpendicular relationship when the wraparound tray preassembly is assembled into the erected wraparound tray.

15. A method for assembling an erected wraparound tray, comprising:
providing a substantially flat wraparound tray preassembly comprising:
a bottom panel;
a front wall comprising a front panel attached to and separated from the bottom panel along a first fold line;
a rear wall comprising a rear panel attached to and separated from the bottom panel along a second fold line; and
a first side wall comprising: a side panel attached to and separated from the bottom panel along a third fold line; a side panel rollover folded into a face to face relationship with the side panel; a glue tab attached to and separated from the side panel rollover by a fourth fold line and secured to the bottom panel; and a first overlapping side panel attached to and separated from one of the front panel and the rear panel by a fifth fold line;
simultaneously folding the side panel and the side panel rollover about the respective third and fourth fold lines so that the side panel and the side panel rollover each assume a substantially perpendicular orientation in relation to the bottom panel;
folding the front panel about the first fold line so that the front panel assumes a substantially perpendicular orientation in relation to the bottom panel;
folding the rear panel about the second fold line so that the rear panel assumes a substantially perpendicular orientation in relation to the bottom panel;
folding the first overlapping side panel about the fifth fold line so that the first overlapping side panel overlaps the side panel; and
securing the first overlapping side panel to the side panel.

16. The method of claim 15, wherein:
the first overlapping side panel is attached to and separated from the rear panel along the fifth fold line; and the first side wall further comprises a second overlapping side panel attached to and separated from the front panel by a sixth fold line; and
the method further comprises: folding the second overlapping side panel about the sixth fold line so that the second overlapping side panel overlaps at least one of the first overlapping side panel and the side panel; and securing the second overlapping side panel to the first overlapping side panel or the second side panel.

17. The method of claim 15, wherein:
the wraparound tray preassembly further comprises a rear panel rollover secured to the rear panel in a face to face relationship with the rear panel; a shelf/filler attached to and separated from the rear panel rollover along a seventh fold line; and a second glue tab attached to and separated from the shelf/filler along an eighth fold line; wherein the shelf/filler has a first half, and a second half attached to and separated from the first half by a ninth fold line; and
the method further comprises folding the shelf/filler around the seventh, eighth, and ninth fold lines so that the first and second halves of the shelf/filler assume a substantially perpendicular relationship.

18. The method of claim 15, wherein:
the wraparound tray preassembly further comprises a second side wall, the second side wall comprising: a side panel attached to and separated from the bottom panel by a tenth fold line; a side panel rollover folded into a face to face relationship with the side panel of the second side wall; a glue tab attached to and separated from the side panel rollover of the second side wall by an eleventh fold line and secured to the bottom panel; and a first overlapping side panel attached to and separated from one of the front panel and the rear panel by a twelfth fold line; and
the method further comprises: simultaneously folding the side panel and the side panel rollover of the second side wall about the respective tenth and eleventh fold lines so that the side panel and the side panel rollover of the second side wall assume a substantially perpendicular orientation in relation to the bottom panel; folding the first overlapping side panel of the second side wall about the twelfth fold line so that the first overlapping side panel of the second side wall overlaps the side panel of the second side wall; and securing the first overlapping side panel of the second side wall to the side panel of the second side wall.

19. The method of claim 18, wherein:
the first overlapping side panel of the second side wall is attached to and separated from the rear panel along the twelfth fold line; and the second side wall further comprises a second overlapping side panel attached to and separated from the front panel by a thirteenth fold line; and
the method further comprises: folding the second overlapping side panel of the second side wall about the thirteenth fold line so that the second overlapping side panel of the second side wall overlaps at least one of the first overlapping side panel and the side panel of the second side wall; and securing the second overlapping side panel of the second side wall to the first overlapping side panel or the second side panel of the second side wall.

20. The method of claim 15, further comprising placing an item to be packaged on the bottom panel before folding the side panel, the side panel rollover; the front panel; the rear panel; and/or
the first overlapping side panel.

21. A blank for forming the wraparound tray preassembly of claim 1.
